(19) United States
(12) Patent Application Publication
(10) Pub. No.: US 2025/0096879 A1
(43) Pub. Date: Mar. 20, 2025

(54) Methods For Sensing Beam Management In Integrated Sensing And Communications System

(71) Applicants: MediaTek Singapore Pte. Ltd., Singapore (SG); Shanghai Jiao Tong University, Shanghai (CN)

(72) Inventors: Aimin Tang, Shanghai (CN); Qimin Zhao, Shanghai (CN); Wenze Qu, Beijing (CN)

(21) Appl. No.: 18/820,209

(22) Filed: Aug. 29, 2024

(30) Foreign Application Priority Data
Sep. 15, 2023 (WO) PCT/CN2023/119131
Aug. 22, 2024 (CN) 202411163801.X

(51) Int. Cl. H04B 7/06; H04B 17/309; H04L 5/00

(52) U.S. Cl. CPC H04B 7/06952; H04B 17/346; H04L 5/0051

(57) ABSTRACT

Various solutions for sensing beam management in integrated sensing and communications (ISAC) system are described. From the receiver's perspective, a sensing receiver may determine or receive a beam configuration and a reference signal (RS) configuration for a sensing of a target object. The sensing receiver may further perform sweeping(s) of receiving (Rx) beam(s) to receive RS(s) based on the beam configuration and the RS configuration. Then, the sensing receiver may perform the sensing of the target object based on the RSs. From the transmitter's perspective, a sensing transmitter may determine or transmit the beam configuration and the RS configuration for the sensing of the target object, and then perform sweeping(s) of transmitting (Tx) beam(s) to transmit the RS(s) based on the beam configuration and the RS configuration.

### CROSS REFERENCE TO RELATED PATENT APPLICATION(S)

The present disclosure is part of a non-provisional application claiming the priority benefit of PCT Application No. PCT/CN2023/119131, filed 15 Sep. 2023, and CN application No. 202411163801.X, filed 22 Aug. 2024. The contents of aforementioned applications are herein incorporated by reference in their entirety.

### TECHNICAL FIELD

The present disclosure is generally related to mobile communications and, more particularly, to sensing beam management in integrated sensing and communications (ISAC) system.

### BACKGROUND

Unless otherwise indicated herein, approaches described in this section are not prior art to the claims listed below and are not admitted as prior art by inclusion in this section.

Mobile communication and radar sensing have been advancing independently for decades. Until recently, the coexistence, cooperation, and joint design of the two systems becomes of interest. Motivation for such topic may include that the use of millimeter waves in 5th generation (5G) and beyond leads to an occupation of adjacent frequency bands, which makes the convergence of the frequency bands used by two systems possible. In addition, with the increasing use of radar sensing in consumer devices and automotive applications, radar systems have entered mass markets. Given that jointly handling communications and sensing on the same architecture or platform would be more cost effective and have lower complexity as compared to two independent platforms, the concept of joint communication and sensing (or called ISAC) is introduced and the beyond 5G (B5G) or 6th Generation (6G) system is envisioned to support sensing service within communication framework.

As the topic is still under study, new design of sensing beam management for ISAC is not yet defined and it has become an important issue for newly developed wireless communication systems. Therefore, there is a need to provide proper schemes to address this issue.

### SUMMARY

The following summary is illustrative only and is not intended to be limiting in any way. That is, the following summary is provided to introduce concepts, highlights, benefits and advantages of the novel and non-obvious techniques described herein. Select implementations are further described below in the detailed description. Thus, the following summary is not intended to identify essential features of the claimed subject matter, nor is it intended for use in determining the scope of the claimed subject matter.

One objective of the present disclosure is proposing schemes, concepts, designs, systems, methods and apparatus pertaining to sensing beam management in ISAC system. It is believed that the above-described issue would be avoided or otherwise alleviated by implementing one or more of the proposed schemes described herein.

In one aspect, a method may involve an apparatus (e.g., a sensing receiver) determining or receiving a beam configuration and a reference signal (RS) configuration for a sensing of a target object. The method may also involve the apparatus performing one or more sweepings of one or more of a plurality of receiving (Rx) beams to receive one or more RSs based on the beam configuration and the RS configuration. The method may further involve the apparatus performing the sensing of the target object based on the RSs.

In one aspect, a method may involve an apparatus (e.g., a sensing transmitter) determining or transmitting a beam configuration and an RS configuration for a sensing of a target object. The method may also involve the apparatus performing one or more sweepings of one or more of a plurality of transmitting (Tx) beams to transmit one or more RSs based on the beam configuration and the RS configuration.

In one aspect, an apparatus may comprise a transceiver which, during operation, wirelessly transmits and receives signals. The apparatus may also comprise a processor communicatively coupled to the transceiver. The processor, during operation, may perform operations comprising determining or receiving, via the transceiver, a beam configuration and an RS configuration for a sensing of a target object. The processor may also perform operations comprising performing, via the transceiver, one or more sweepings of one or more of a plurality of Rx beams to receive one or more RSs based on the beam configuration and the RS configuration. The processor may further perform operations comprising performing, via the transceiver, the sensing of the target object based on the RSs.

It is noteworthy that, although description provided herein may be in the context of certain radio access technologies (RATs), networks and network topologies such as Long-Term Evolution (LTE), LTE-Advanced, LTE-Advanced Pro, 5G, New Radio (NR), Internet-of-Things (IoT) and Narrow Band Internet of Things (NB-IoT), Industrial Internet of Things (IIoT), B5G, and 6G, the proposed concepts, schemes and any variation(s)/derivative(s) thereof may be implemented in, for and by other types of radio access technologies, networks and network topologies. Thus, the scope of the present disclosure is not limited to the examples described herein.

### BRIEF DESCRIPTION OF THE DRAWINGS

The accompanying drawings are included to provide a further understanding of the disclosure and are incorporated in and constitute a part of the present disclosure. The drawings illustrate implementations of the disclosure and, together with the description, serve to explain the principles of the disclosure. It is appreciable that the drawings are not necessarily in scale as some components may be shown to be out of proportion than the size in actual implementation in order to clearly illustrate the concept of the present disclosure.

FIG. 1 is a diagram depicting example scenarios of a communication environment in which various solutions and schemes in accordance with the present disclosure may be implemented.

FIG. 2 is a diagram depicting an example scenario of Tx and Rx beampatterns during beam sweeping for monostatic sensing in accordance with an implementation of the present disclosure.

FIG. 3 is a diagram depicting an example scenario of Tx and Rx beampatterns during beam sweeping for monostatic sensing in accordance with an implementation of the present disclosure.

FIG. 4 is a diagram depicting an example scenario of Tx and Rx beampatterns during beam sweeping for monostatic sensing in accordance with an implementation of the present disclosure.

FIG. 5 is a diagram depicting an example scenario of Tx and Rx beampatterns during beam sweeping for monostatic sensing in accordance with an implementation of the present disclosure.

FIG. 6 is a diagram depicting an example scenario of Tx and Rx beampatterns during beam sweeping for bistatic sensing in accordance with an implementation of the present disclosure.

FIG. 7 is a diagram depicting an example scenario of Tx and Rx beampatterns during beam sweeping for bistatic sensing in accordance with an implementation of the present disclosure.

FIG. 8 is a diagram depicting an example scenario of Tx and Rx beampatterns during beam sweeping for bistatic sensing in accordance with an implementation of the present disclosure.

FIG. 9 is a diagram depicting an example scenario of Tx and Rx beampatterns during beam sweeping for bistatic sensing in accordance with an implementation of the present disclosure.

FIG. 10 is a diagram depicting an example scenario of Tx and Rx beampatterns for beam tracking in monostatic sensing and bistatic sensing in accordance with an implementation of the present disclosure.

FIG. 11 is a flowchart of an example process of beam management for monostatic sensing in accordance with an implementation of the present disclosure.

FIG. 12 is a flowchart of an example process of beam management for bistatic sensing in accordance with an implementation of the present disclosure.

FIG. 13 is a diagram depicting an example scenario of resource allocation for RS configuration in accordance with an implementation of the present disclosure.

FIG. 14 is a diagram depicting an example scenario of a signaling interaction mechanism applied during beam management for monostatic sensing in accordance with an implementation of the present disclosure.

FIG. 15 is a diagram depicting an example scenario of a signaling interaction mechanism applied during beam management for monostatic sensing in accordance with an implementation of the present disclosure.

FIG. 16 is a diagram depicting an example scenario of a signaling interaction mechanism applied during beam management for bistatic sensing in accordance with an implementation of the present disclosure.

FIG. 17 is a diagram depicting an example scenario of a signaling interaction mechanism applied during beam management for bistatic sensing in accordance with an implementation of the present disclosure.

FIG. 18 is a block diagram of an example communication system in accordance with an implementation of the present disclosure.

FIG. 19 is a flowchart of an example process in accordance with an implementation of the present disclosure.

FIG. 20 is a flowchart of another example process in accordance with an implementation of the present disclosure.

### DETAILED DESCRIPTION OF PREFERRED IMPLEMENTATIONS

Detailed embodiments and implementations of the claimed subject matters are disclosed herein. However, it shall be understood that the disclosed embodiments and implementations are merely illustrative of the claimed subject matters which may be embodied in various forms. The present disclosure may, however, be embodied in many different forms and should not be construed as limited to the exemplary embodiments and implementations set forth herein. Rather, these exemplary embodiments and implementations are provided so that description of the present disclosure is thorough and complete and will fully convey the scope of the present disclosure to those skilled in the art. In the description below, details of well-known features and techniques may be omitted to avoid unnecessarily obscuring the presented embodiments and implementations.

### Overview

Implementations in accordance with the present disclosure relate to various techniques, methods, schemes and/or solutions pertaining to sensing beam management in ISAC system. According to the present disclosure, a number of possible solutions may be implemented separately or jointly. That is, although these possible solutions may be described below separately, two or more of these possible solutions may be implemented in one combination or another.

In the present disclosure, a wide beam generally refers to a beam with a relatively large signal coverage than a narrow beam. For example, a narrow beam may be formed by configuring multiple or all antenna subarrays to point towards a specific angle, while a wide beam may be formed by configuring one antenna subarray to point towards a specific angle or configuring different antenna subarrays to point towards different angles.

The ISAC design is a critical technique for B5G/6G networks, which enables the widely deployed communication systems to be perceptive. In ISAC systems, beam management is indispensable for both communications and sensing, so that the appropriate Tx and Rx beam pairs may be determined for beamforming and beam tracking. Conventionally, the beam management is standardized for communications in the 3^{rd} generation partnership project (3GPP). Considering the differences between communications and sensing, the beam management for sensing is to be explored. In view of the above, the present disclosure proposes a number of schemes pertaining to sensing beam management in ISAC system. According to the schemes of the present disclosure, procedures of sensing beam management, including system configuration, beam sweeping, beam measurement, beam determination, and beam tracking, for monostatic sensing and bistatic sensing are proposed, as well as the signaling interaction mechanisms for assisting the aforementioned procedures.

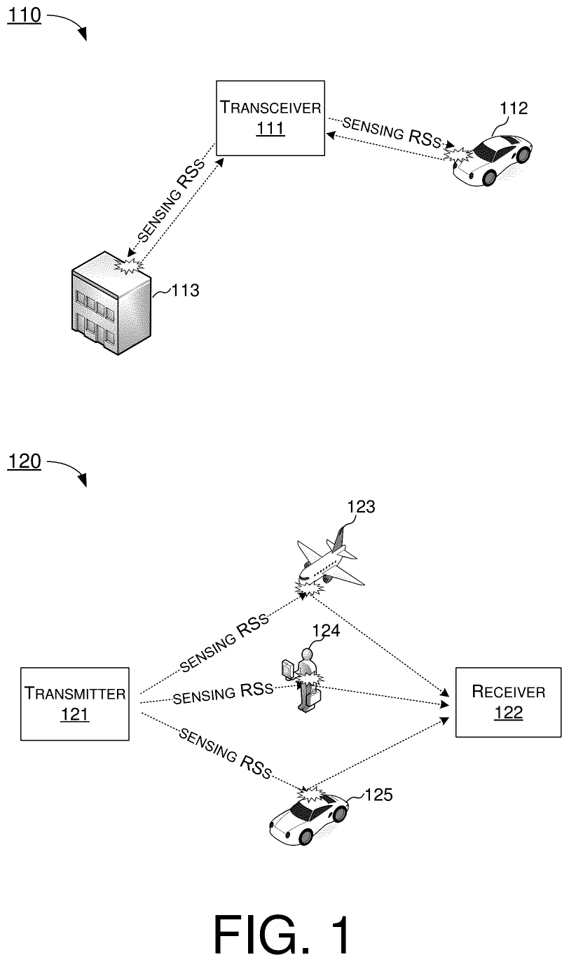

FIG. 1 illustrates example scenarios 110 and 120 of a communication environment in which various solutions and schemes in accordance with the present disclosure may be implemented. Scenario 110 depicts an ISAC system including a transceiver 111 and one or more target objects 112 and 113, wherein the transceiver 111 supports monostatic sensing for any of the target objects 112 and 113. In monostatic sensing, the transmitter unit and receiver unit are generally co-located (e.g., within a single device) (or connected with fiber and act as distributed monostatic system), and thus share complete knowledge of the transmitted signals and the clock. On the other hand, scenario 120 depicts another ISAC system including a transmitter 121, a receiver 122, and one or more target objects 123-125, wherein the transmitter 121 and the receiver 122 supports bistatic sensing for any of the target objects 123-125. In bistatic sensing, the transmitter 121 and the receiver 122 are usually at different locations, where the receiver 122 may only have partial knowledge of the transmitted signals and certain synchronization (e.g., clock synchronization) between the transmitter 122 and the receiver 122 may be required.

It is noteworthy that wireless sensing is incorporated into the ISAC systems in scenarios 110 and 120. For monostatic sensing, the transceiver 111 may transmit a communication signal with specific RS configurations (e.g., a sensing RS) and receive the reflection signal from the target objects 112 and 113 distributed in the environment. For bistatic sensing, the transmitter 121 may transmit a communication signal with specific RS configurations (e.g., a sensing RS) and the receiver 122 may receive the reflection signal from the target objects 123-125 distributed in the environment. Then, based on the received signal, typical sensing algorithms, such as the periodogram-based algorithm, and the compressive sensing algorithms, may be applied to obtain target information (e.g., angle, distance, and velocity).

Each of the transceiver 111, the transmitter 121, and the receiver 122 may function as a user equipment (UE) or a base station (BS). In one example, the transmitter 121 may be a BS and the receiver 122 may be a UE, or the transmitter 121 may be a UE and the receiver 122 may be a BS. In another example, the transmitter 121 and the receiver 122 may be two BSs or two UEs. The UE may include a smartphone, a smartwatch, a personal digital assistant, a digital camera, a tablet computer, a laptop computer, a notebook computer, or an IoT/NB-IoT/IIoT apparatus. The BS may include an evolved NodeB (eNB) in 4G LTE, a next-generation NB (gNB) or a transmission and reception point (TRP) in 5G NR, or a B5G/6G NB. In such a communication environment, the transceiver 111, or the transmitter 121 and the receiver 122 may implement various schemes pertaining to sensing beam management in ISAC system in accordance with the present disclosure, as described below. It is noteworthy that, while the various proposed schemes may be individually or separately described below, in actual implementations some or all of the proposed schemes may be utilized or otherwise implemented jointly. Of course, each of the proposed schemes may be utilized or otherwise implemented individually or separately.

In the present disclosure, different applications correspond to different sensing requirements. Depending on a specific application, the transmitter and the receiver may firstly obtain the corresponding sensing requirements, including the sensing scenarios, the maximum detection angle, distance and velocity of interest, the radar cross section (RCS), and the timeliness of sensing. Specifically, the sensing scenarios may be divided into monostatic sensing and bistatic sensing, as shown in FIG. 1. For example, the sensing scenario is monostatic sensing if the transmitter and the (radar) receiver are collocated, or otherwise it is bistatic sensing. The maximum detection angle, distance and velocity are associated with the detection area of interest. For example, in vehicular scenarios, the desired detection distance and velocity may be determined based on common sense, and the anticipated detection angle may be associated with the geographical relationship among the transmitter, the road, and the receiver in practice. The RCS may be approximated based on the empirical observation, which plays a significant part in determining the sensing signal-to-noise ratio (SNR). For example, the vehicular RCS is 20 dBsm. The timeliness of sensing may also be related to a specific application. For example, the sensing information demands to be timely updated especially for some security-prioritized scenarios, such as collision avoidance, etc.

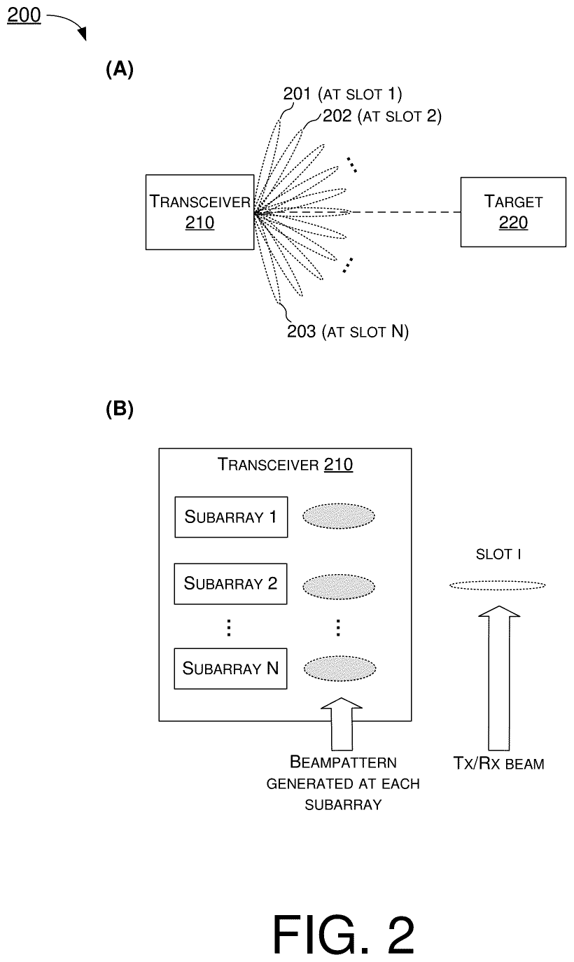

Since the target objects (e.g., target objects 112-113 or 123-125) are randomly distributed in the detection area of interest, beam sweeping is conducted to detect the target objects. Depending on the specific application and the corresponding sensing requirements, the appropriate Tx and Rx beampatterns during beam sweeping are proposed, including three cases for monostatic sensing and three cases for bistatic sensing as will be discussed below in FIGS. 2 to 5 and FIGS. 6 to 9, respectively.

FIG. 2 illustrates an example scenario 200 of Tx and Rx beampatterns during beam sweeping for monostatic sensing in accordance with an implementation of the present disclosure. Scenario 200 depicts case 1 preferred for detecting target objects at long distance, where the Tx and Rx beams are narrow beams with high beam gain, as shown in part (A) of FIG. 2. Case 1 utilizes all antenna subarrays to get a one-direction beam and has the highest beam gain for each sweep, where there is no need to change the existing codebook. Particularly, the Tx and Rx beams are aligned with each other, i.e., the angle of arrival (AoA) is equal to the angle of departure (AoD). Since the beam width is narrow, the beam sweeping interval is also small, which may lead to more sweeping times to complete the traversal search of the entire detection area. The Tx and Rx beams 201-203 continuously sweep with a given sweeping interval (e.g., one time slot) to cover the entire detection area. To generate the Tx and Rx beampatterns at the transceiver 210 during each beam sweeping, all the antenna subarrays point towards a specific angle to form a narrow beam at a time (denoted as slot i), as shown in part (B) of FIG. 2. In this way, the codebook may be compatible with the existing communication infrastructures (e.g., 5G NR).

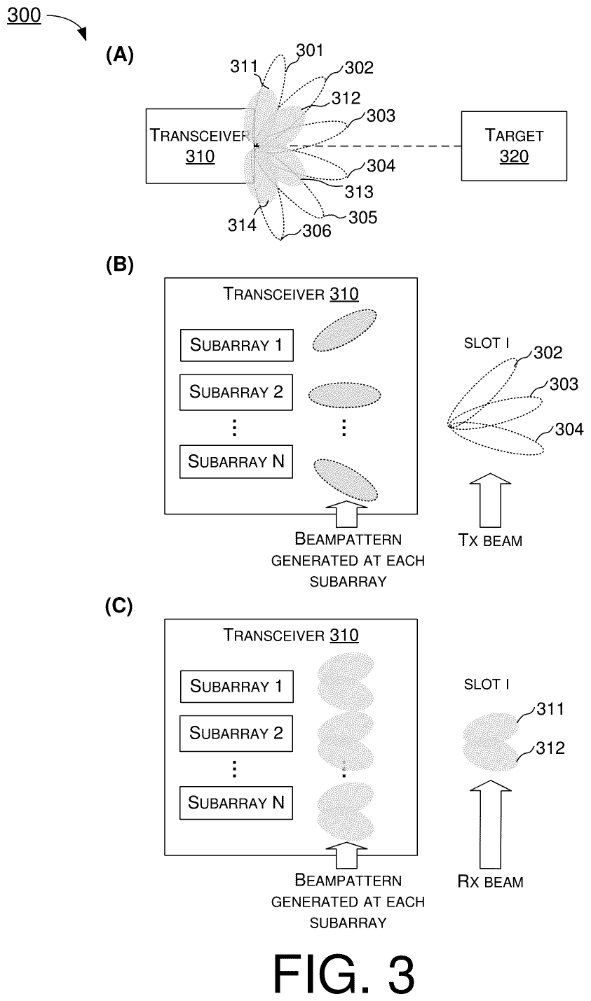

FIG. 3 illustrates an example scenario 300 of Tx and Rx beampatterns during beam sweeping for monostatic sensing in accordance with an implementation of the present disclosure. Scenario 300 depicts the case (i.e., case 2) preferred for quickly detecting target objects at short distance, where multiple wide Tx and Rx beams are generated simultaneously, as shown in part (A) of FIG. 3. Case 2 makes each antenna subarray to point towards different directions simultaneously, which is preferred for quickly detecting targets at short detection distance. Particularly, the Tx and Rx beams are aligned with each other, i.e., the AoA is equal to the AoD. Since the beam width is wide, the sweeping interval is large and hence, this case may have the least sweeping times (with low beam gain as a sacrifice). The Tx beams 301-306 and Rx beams 311-314 continuously sweep with a given sweeping interval to cover the entire detection area. To generate the Tx and Rx beampatterns at the transceiver 310 during each sweeping, the Tx beams 301-306 and Rx beams 311-314 are generated/formed in different ways. To form wide TX beams 301-306, each antenna subarray points towards different widely-spaced angles, as shown in part (B) of FIG. 3. To form wide RX beams 311-314, each antenna subarray points toward multiple directions, and all the antenna subarrays follow the same pattern, as shown in part (C) of FIG. 3. In this way, each antenna subarray may receive the signals reflected from multiple directions simultaneously, and the sensing algorithms such as fast Fourier transform (FFT) may be applied for angle estimation. To this end, the existing codebook may need to be altered due to the received beampattern. Additionally, the Rx codewords in case 2 are designed for beam split, so as to estimate AoA via sensing algorithms for multiple directions simultaneously.

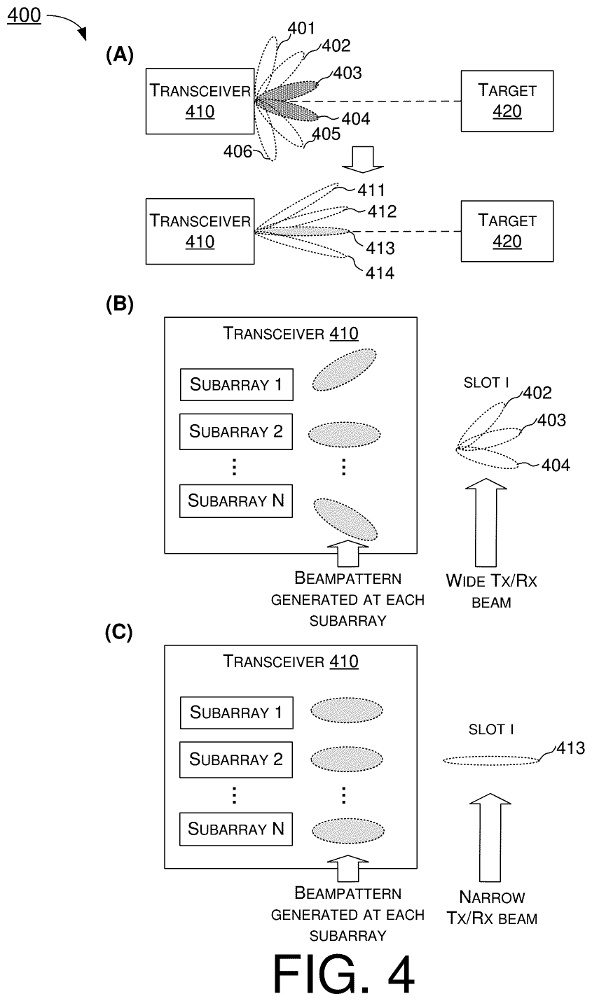

FIG. 4 illustrates an example scenario 400 of Tx and Rx beampatterns during beam sweeping for monostatic sensing in accordance with an implementation of the present disclosure. Scenario 400 depicts the case (i.e., case 3) aiming to achieve a tradeoff between case 1 and case 2 in terms of beam gain and sweeping times, where the codebook is compatible with the existing communication infrastructures (e.g., 5G NR). Case 3 utilizes different antenna subarrays to point towards different directions, and can achieve a tradeoff between case 1 and case 2. Specifically, there are two phases of beam sweeping, including wide beam sweeping and narrow beam sweeping, as shown in part (A) of FIG. 4. During the wide beam sweeping, at the transceiver 410, the Tx and Rx beams 401-406 simultaneously align with multiple directions, and are generated in the same way. Particularly, the Tx and Rx beams 401-406 are aligned with each other, i.e., the AoA is equal to the AoD. The Tx and Rx beams 401-406 continuously sweep with a given sweeping interval to cover the entire detection area. To form wide Tx and Rx beams, each antenna subarray points toward a single direction, but the directions vary for different antenna subarrays, as shown in part (B) of FIG. 4. After the entire wide beam sweeping, several wide beams are selected as candidates for beam refinement based on the procedures of beam measurement and beam determination. For example, the Tx beams 403 and 404 are regarded as candidate wide beams for beam refinement. During the narrow beam sweeping, to generate narrow Tx and Rx beams 411-414, all the antenna subarrays point towards a specific angle, as shown in part (C) of FIG. 4. The transceiver 410 scans (i.e., sweeps through) narrow beams 411-414 within the candidate wide beams 403-404. Particularly, the Tx and Rx beams 411-414 are aligned with each other, i.e., the AoA is equal to the AoD.

Accordingly, by applying the schemes of the present disclosure, either one or a combination of the aforementioned three cases of Tx and Rx beampatterns during beam sweeping for monostatic sensing may be selected according to the sensing requirements, to achieve high estimation accuracy and high efficiency of resource utilization. More specifically, case 1 is preferred for long distance detection and has the highest beam gain for each sweeping, but comes with a cost of resulting more sweeping times. In addition, case 1 does not need to introduce modifications to the existing codebook. On the other hand, case 2 is preferred for quick detection at short distance and has the least sweeping times, but comes with a cost of reduced beam gain. However, case 2 may need to introduce modifications to the existing codebook, due to the Rx beampattern. Furthermore, case 3 achieves a tradeoff between case 1 and case 2, and is also compatible with the existing codebook. Additionally, if multiple carriers are configured, these three cases of Tx and Rx beampatterns during beam sweeping for monostatic sensing may be used at the same time on different carriers to improve beam sweeping efficiency.

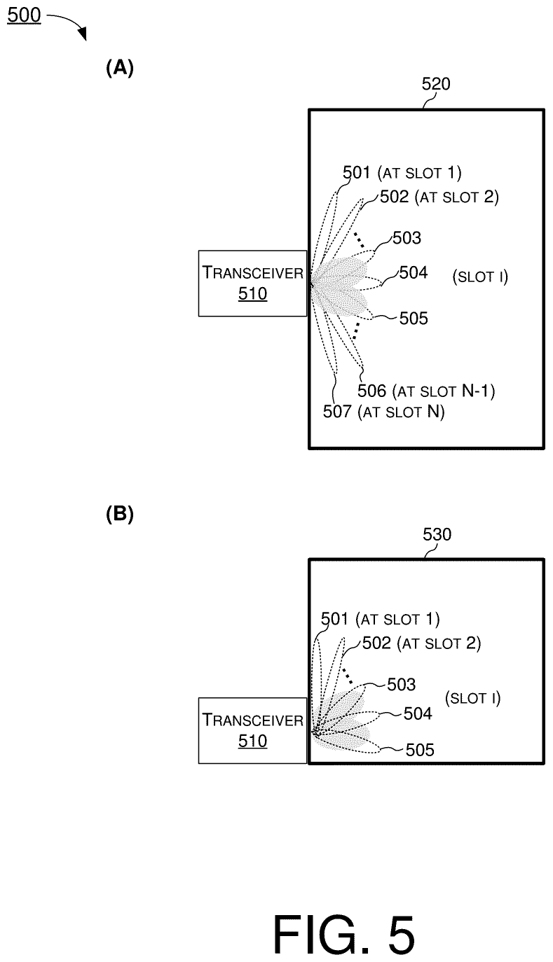

FIG. 5 illustrates an example scenario 500 of Tx and Rx beampatterns during beam sweeping for monostatic sensing in accordance with an implementation of the present disclosure. Scenario 500 involves a transceiver 510 combining the aforementioned three cases for mixed sensing requirements in monostatic sensing. Given the detection area of interest 520 as shown in part (A) of FIG. 5, the Tx/Rx beams 501-502 and 506-507 adopt the beampatterns in case 1 (as depicted in FIG. 2) to detect target objects at longer distance, and the Tx/Rx beams 503-505 adopt the beampatterns in case 2 (as depicted in FIG. 3) to detect target objects at shorter distance. Given the detection area of interest 530 as shown in part (B) of FIG. 5, different Tx/Rx beams are activated collaboratively during beam sweeping, since the detection area 530 is different from the detection area 520. For example, the Tx/Rx beams 506-507 may be unnecessary or redundant in the detection area 530, and hence, only partial beams are demanded during beam sweeping for the detection area 530, to improve efficiency of resource utilization and beam sweeping.

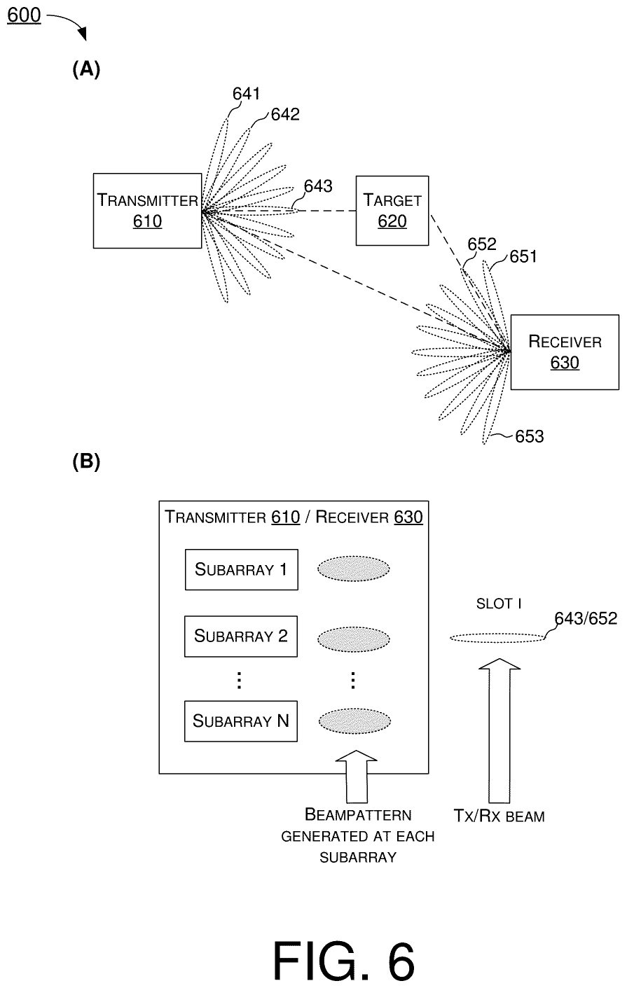

FIG. 6 illustrates an example scenario 600 of Tx and Rx beampatterns during beam sweeping for bistatic sensing in accordance with an implementation of the present disclosure. Scenario 600 depicts the case (i.e., case 1) preferred for detecting target objects at long distance, where the Tx and Rx beams are narrow beams with high beam gain. Since the beam width is narrow, the sweeping interval is also small, which may lead to more sweeping times to complete the traversal search of the entire detection area. Given a fixed Rx beam 651/652/653, the Tx beams 641-643 continuously sweep with a given sweeping interval to cover more intersection area, as shown in part (A) of FIG. 6. To generate the Tx and Rx beampattern at the transmitter 610 and the receiver 630 during each beam sweeping, all antenna subarrays point towards a specific angle to form a narrow beam, as shown in part (B) of FIG. 6. In this way, the codebook may be compatible with the existing communication infrastructures (e.g., 5G NR).

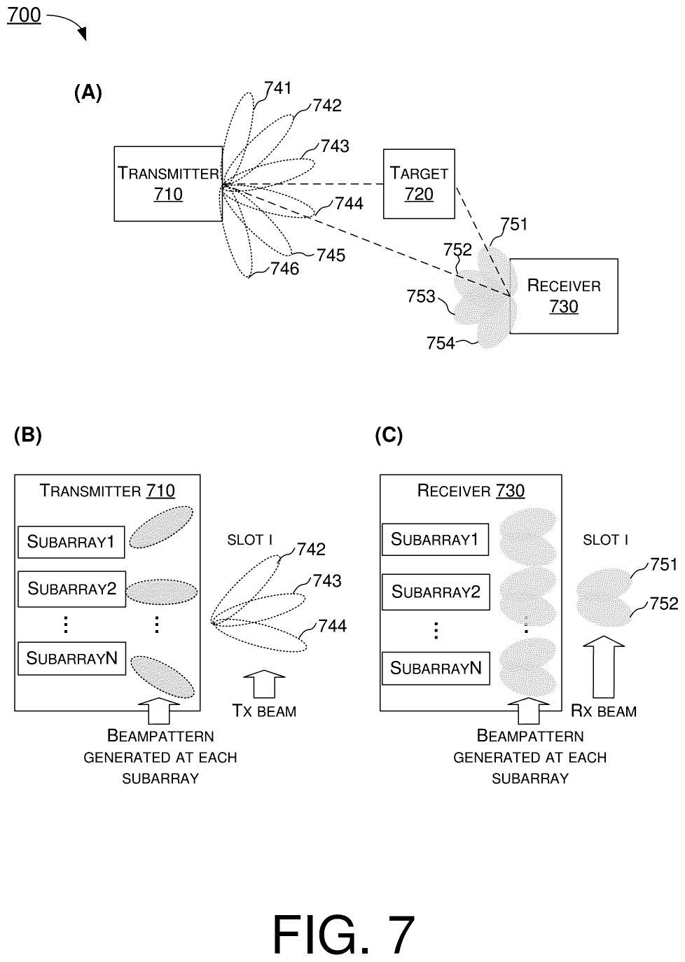

FIG. 7 illustrates an example scenario 700 of Tx and Rx beampatterns during beam sweeping for bistatic sensing in accordance with an implementation of the present disclosure. Scenario 700 depicts the case (i.e., case 2) preferred for quickly detecting target objects at short distance, where multiple wide Tx and Rx beams are generated simultaneously. Given the fixed Rx beams 751-754, the Tx beams 741-746 continuously sweep with a given sweeping interval to cover more intersection area, as shown in part (A) of FIG. 7. Since the beam width is wide, the sweeping interval is large and hence, this case may have the least sweeping times (with low beam gain as a sacrifice). The wide Tx and Rx beams are generated/formed in different ways. To generate the wide Tx beams 741-746 at the transmitter 710 during each sweeping, each antenna subarray points towards different widely-spaced angles, as shown in part (B) of FIG. 7. To generate the wide Rx beams 754-754 at the receiver 730, each antenna subarray points toward multiple directions, but all antenna subarrays follow the same pattern, as shown in part (C) of FIG. 7. In this way, each antenna subarray may receive the signals reflected from multiple directions simultaneously, and the sensing algorithms such as FFT may be applied for angle estimation. To this end, the codebook for this case needs to be carefully designed for the received beampattern, i.e., the existing codebook may need to be altered due to the received beampattern.

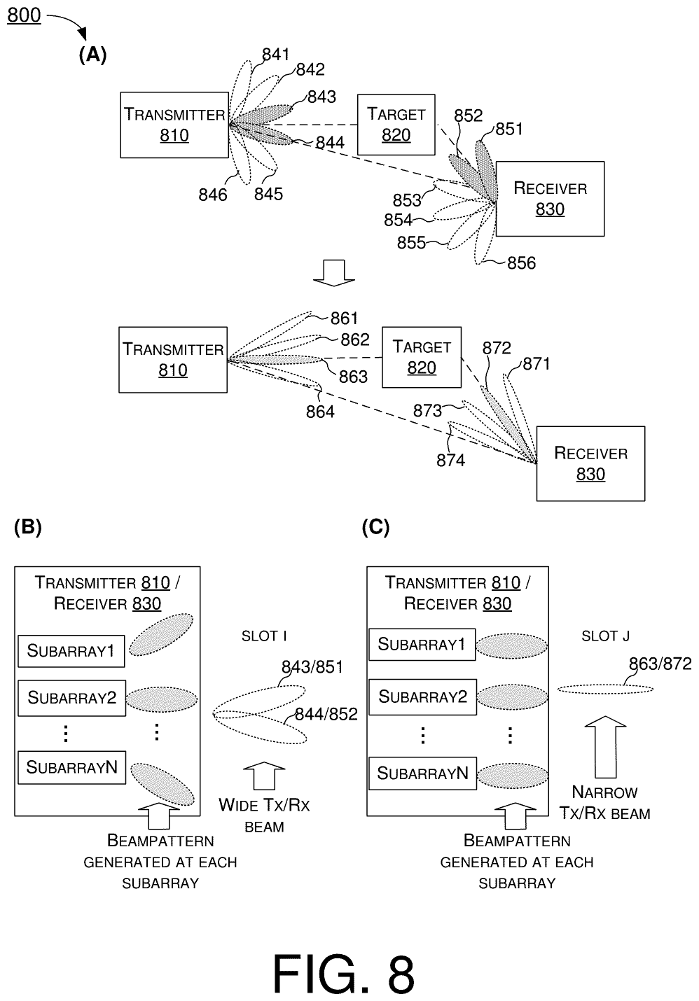

FIG. 8 illustrates an example scenario 800 of Tx and Rx beampatterns during beam sweeping for bistatic sensing in accordance with an implementation of the present disclosure. Scenario 800 depicts the case (i.e., case 3) aiming to achieve a tradeoff between case 1 and case 2 in terms of beam gain and sweeping times, where the codebook is compatible with the existing communication infrastructures (e.g., 5G NR). Specifically, there are two phases of beam sweeping, including wide beam sweeping and narrow beam sweeping, as shown in part (A) of FIG. 8. During the wide beam sweeping, the Tx beams 841-846 at the transmitter 810 and the Rx beams 851-856 at the receiver 830 simultaneously align with multiple directions, and are generated in the same way. Given a fixed Rx beam 851/852/853/854/855/856, the Tx beams 841 to 846 continuously sweep with a given sweeping interval to cover the intersection area. After the wide beam sweeping, several wide beams are selected as candidates for beam refinement based on the procedures of beam measurement and determination. For example, the Tx beams 843 and 844 and the Rx beams 851 and 852 are regarded as candidate wide beams for the next phase-narrow beam sweeping. To form wide Tx and Rx beams, each antenna subarray points toward a single direction, but the directions vary for different antenna subarrays, as shown in part (B) of FIG. 8. During the narrow beam sweeping, to generate narrow Tx beams 861-864 and narrow Rx beams 871-874, all antenna subarrays point towards a specific angle, as shown in part (C) of FIG. 8. The transmitter 810 scans (i.e., sweeps through) the narrow Tx beams 861-864 within the candidate wide Tx beams 843-844, and the receiver 830 scans (i.e., sweeps through) the narrow Rx beams 871-874 within the candidate wide Rx beams 851 and 852.

Accordingly, by applying the schemes of the present disclosure, either one or a combination of the aforementioned three cases of Tx and Rx beampatterns during beam sweeping for bistatic sensing may be selected according to the sensing requirements, to achieve high estimation accuracy and high efficiency of resource utilization. More specifically, case 1 is preferred for long distance detection and has the highest beam gain for each sweeping, but comes with a cost of resulting more sweeping times. In addition, case 1 does not need to introduce modifications to the existing codebook. On the other hand, case 2 is preferred for quick detection at short distance and has the least sweeping times, but comes with a cost of reduced beam gain. However, case 2 may need to introduce modifications to the existing codebook due to the Rx beampattern. Furthermore, case 3 achieves a tradeoff between case 1 and case 2, and is also compatible with the existing codebook. Additionally, if multiple carriers are configured, these three cases of Tx and Rx beampatterns during beam sweeping for bistatic sensing may be used at the same time on different carriers to improve beam sweeping efficiency.

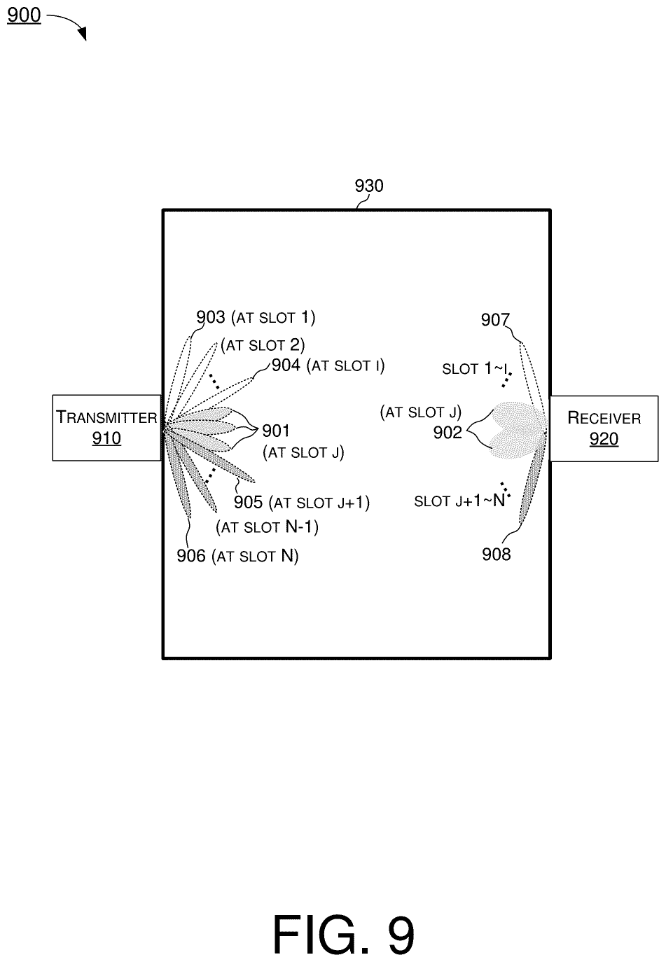

FIG. 9 illustrates an example scenario 900 of Tx and Rx beampatterns during beam sweeping for bistatic sensing in accordance with an implementation of the present disclosure. Scenario 900 involves a transmitter 910 and a receiver 920 combining the aforementioned three cases for mixed sensing requirements in bistatic sensing. Given the detection area of interest 930 as shown in FIG. 9, the Tx beams 903-906 and the Rx beams 907-908 adopt the beampatterns in case 1 (as depicted in FIG. 6) to detect target objects at longer distance, while the Tx beams 901 and the RX beams 902 adopt the beampatterns in case 2 (as depicted in FIG. 7) to detect target objects at shorter distance. Given a fixed Rx beam, only partial Tx beams are activated collaboratively during beam sweeping for bistatic sensing according to the detection area, to improve efficiency of resource utilization and beam sweeping. In one example, given a fixed Rx beam 907, only the partial Tx beams 903-904 are required to cover the intersection area, while the remaining Tx beams 901 and 905-906 are redundant and omitted since they have no intersection with the Rx beam 907. In one example, given a fixed Rx beam 902, only partial Tx beam(s) (e.g., Tx beam 901) is/are required to cover the intersection area, while the remaining Tx beams 903-906 are redundant and omitted since they have no intersection with the Rx beam 902. In one example, given a fixed Rx beam 908, only partial Tx beams 905-906 are required to cover the intersection area, while the remaining Tx beams 901 and 903-904 are redundant and omitted since they have no intersection with the Rx beam 908.

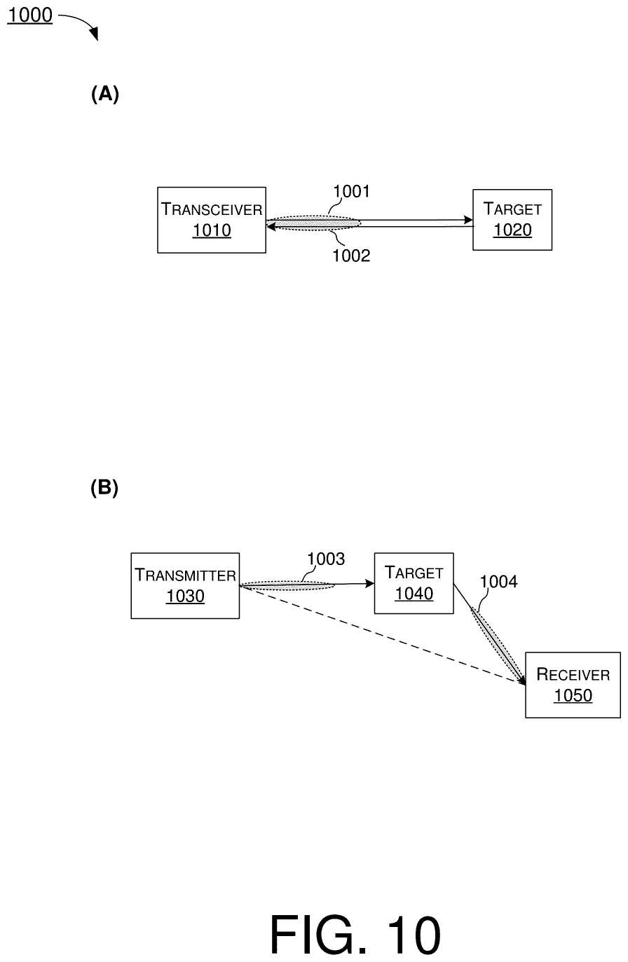

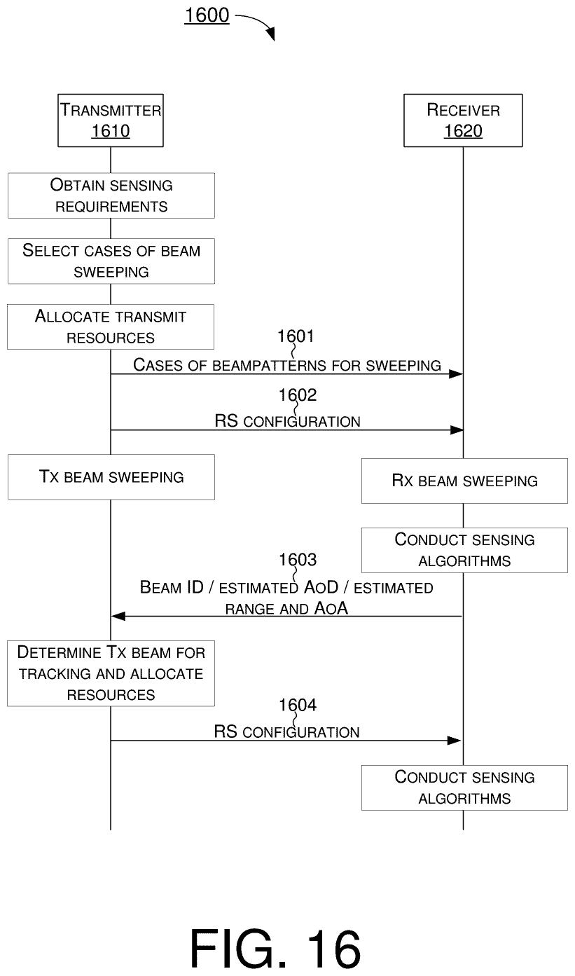

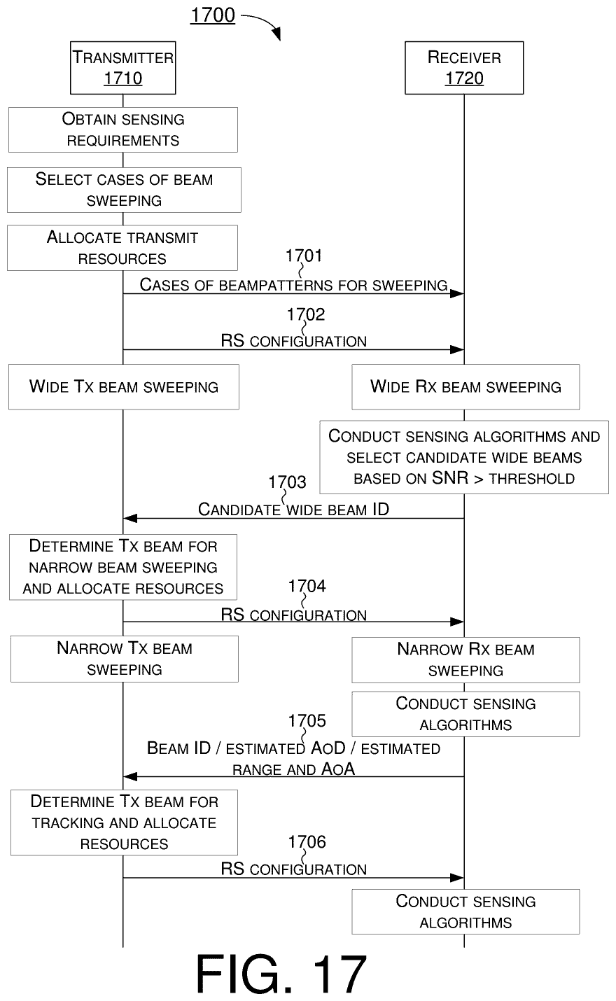

FIG. 10 illustrates an example scenario 1000 of Tx and Rx beampatterns for beam tracking in monostatic sensing and bistatic sensing in accordance with an implementation of the present disclosure. Part (A) of FIG. 10 depicts the monostatic sensing scenario, while part (B) of FIG. 10 depicts the bistatic sensing scenario. As shown in part (A) of FIG. 10, given the estimated target AoA, the transceiver 1010 sets the AoD equal to the AoA, i.e., the directions of the Tx beam 1001 and the Rx beam 1002 are the same. The transceiver 1010 transmits a communication signal with a specific RS configuration (e.g., a sensing RS) via the narrow Tx beam 1001 and receives the reflection signal from the tracked target object 1020 via the narrow Rx beam 1002. To generate the directional beams 1001 and 1002 with high beam gain, all antenna subarrays point towards the estimated target AoD. As shown in part (B) of FIG. 10, given the estimated target AoA, the AoD may be determined and obtained by the transmitter 1030 via certain signaling interaction mechanism (as will be discussed below in FIGS. 16-17). The transmitter 1030 transmits a communication signal with a specific RS configuration (e.g., a sensing RS) via the narrow Tx beam 1003 according to the AoD, and the receiver 1050 receives the reflection signal from the tracked target object 1040 via the narrow Rx beam 1004 according to the AoA. To generate the directional beams 1003 and 1004 with high beam gain, all antenna subarrays point towards the estimated target AoD and AoA, respectively.

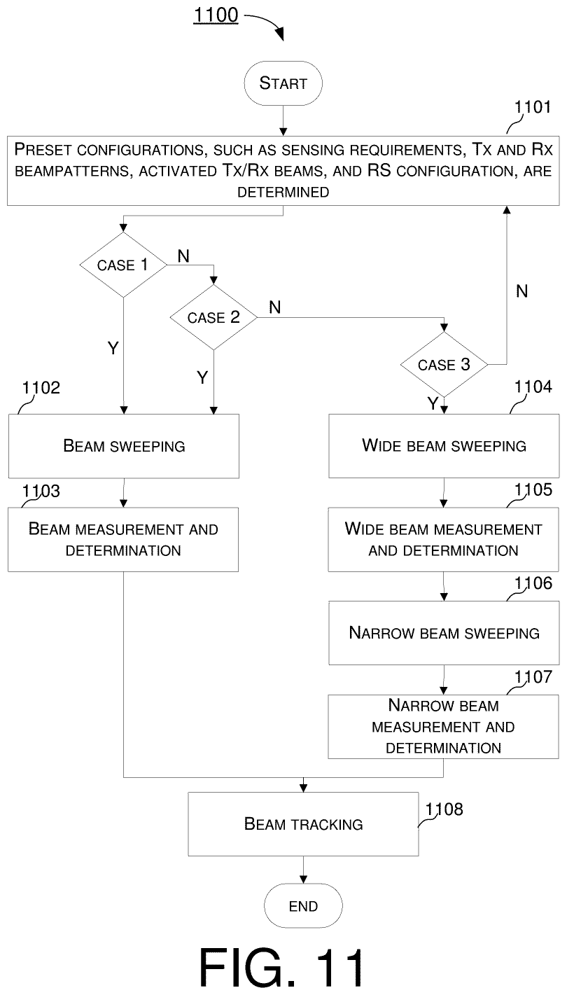

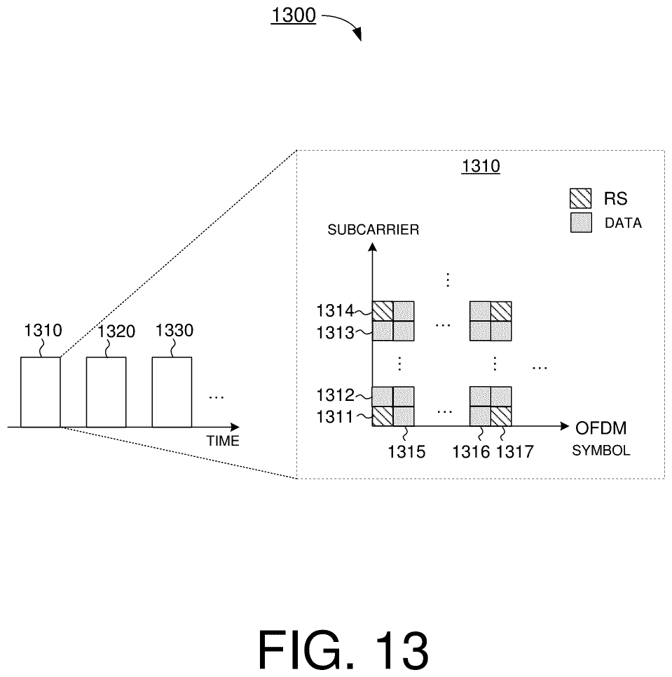

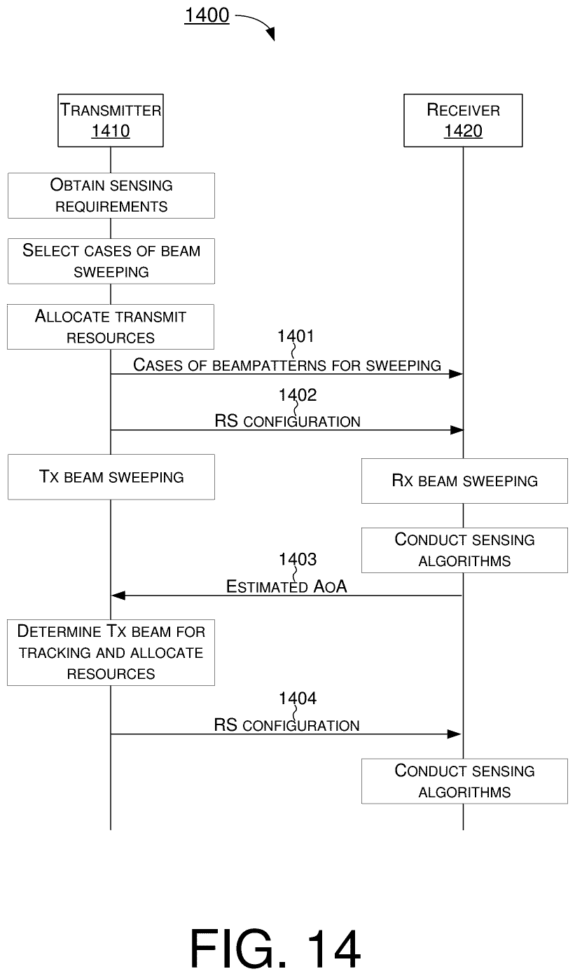

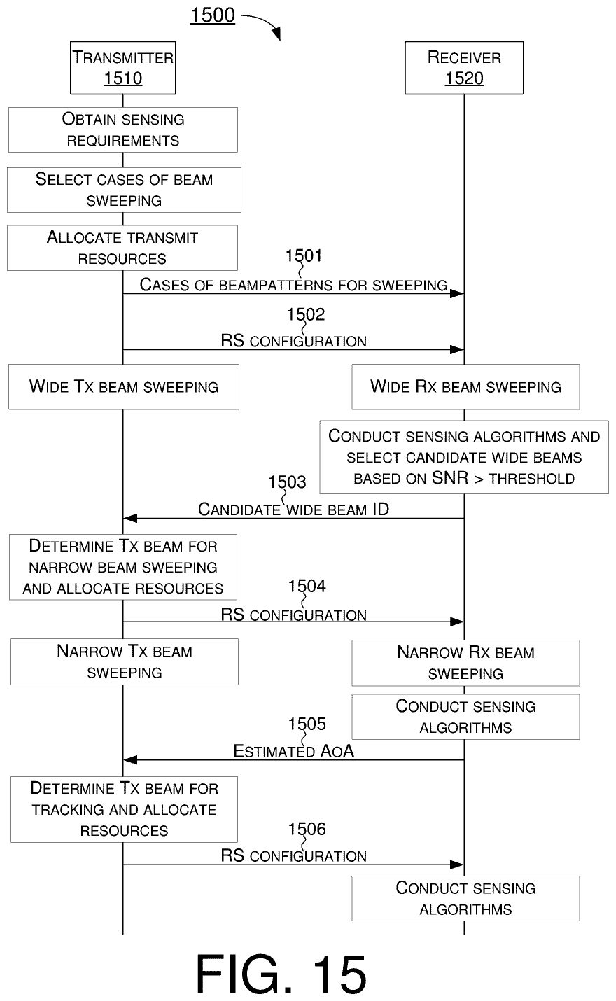

FIG. 11 illustrates an example process 1100 of beam management for monostatic sensing in accordance with an implementation of the present disclosure. Process 1100 includes multiple steps that may be executed by a transceiver (e.g., a UE or BS). To begin with, in step 1101, preset configurations, including the sensing requirements, the Tx and Rx beampatterns during beam sweeping, the activated Tx/Rx beams, and RS configuration, etc., are determined by the transceiver. The sensing requirements may be obtained by the transceiver via certain signaling interaction mechanism (as will be discussed below in FIGS. 14-15), and the sensing requirements may include the sensing scenario (i.e., monostatic sensing or bistatic sensing), the maximum detection angle, distance and velocity of interest, the RCS, and the timeliness of sensing, etc. Based on the sensing requirements, if the sensing scenario is monostatic sensing, the appropriate Tx and Rx beampatterns during beam sweeping may be selected among the three cases previously depicted in FIGS. 2-4. Based on the detection area, only partial Tx/Rx beams may be activated for beam sweeping. Given the selected Tx and Rx beampatterns during beam sweeping, the RS may be configured for the sensing requirements at the transceiver (as will be discussed below in FIG. 13). Different service requirements may correspond to different RS configurations. For example, the maximum detection velocity may be associated with the OFDM symbol spacing between two RSs, the maximum detection distance may be associated with the subcarrier spacing between two RSs, and the total number of resource elements allocated to RS may contribute to radar processing gain.

Subsequent to step 1101, if case 1 or case 2 is adopted, process 1100 may proceed to 1102. In step 1102, beam sweeping(s) is/are performed. Based on the Tx and Rx beampatterns as shown in FIG. 2 and FIG. 3, the transceiver is continuously aligned with different directions, given a sweeping interval to cover the entire detection area. The Tx and Rx beams are aligned with each other, i.e., the AoA is equal to the AoD. In step 1103, beam measurement and determination are performed. For each sweeping, the radar receiver receives the reflection signal from the target object and conducts the sensing algorithm, such as periodogram-based algorithms, to estimate the target AoA, distance, and velocity. Once the target AoA is measured and estimated, the target AoD is determined accordingly, since the AoD is equal to AoA for monostatic sensing.

Subsequent to step 1101, if case 3 is adopted, process 1100 may proceed to 1104. In step 1104, the transceiver first performs wide beam sweeping. Given a wide sweeping interval, the transceiver continuously aligns with different directions to cover the entire detection area. The AoA is equal to the AoD. In step 1105, wide beam measurement and determination are performed. For each wide beam sweeping, the radar receiver receives the reflection signal from the target object, and conducts the sensing algorithm to obtain the Range-Doppler (RD) map. The radar receiver may record the SNR of the sensing target in the RD map and select several candidate wide beams with the sensing SNR above the threshold. For example, as shown in part (A) of FIG. 4, the beams 403 and 404 are regarded as candidate wide beams for the next phase-narrow beam sweeping. In step 1106, the Tx and Rx narrow beams are generated for narrow beam sweeping (as shown in part (B) of FIG. 4). Given a narrow sweeping interval, the transceiver scans narrow beams (e.g., beams 411-414) within the candidate wide beams (e.g., beams 403 and 404). The AoA is equal to the AoD. In step 1107, narrow beam measurement and determination are performed. For each narrow beam sweeping, the radar receiver receives the reflection signal from the target object and conducts the sensing algorithms, such as periodogram-based algorithm. The AoA may be estimated via the narrow beampattern.

Subsequent to steps 1103 and 1107, process 1100 may proceed to 1108. In step 1108, beam tracking is performed (e.g., with the Tx and Rx beampatterns for beam tracking as shown in part (A) of FIG. 10). Given the estimated target AoA, the transceiver sets the AoD equal to the AoA. To generate directional Tx and Rx beams with high beam gain, all antenna subarrays point towards the estimated target AoD and AoA, respectively.

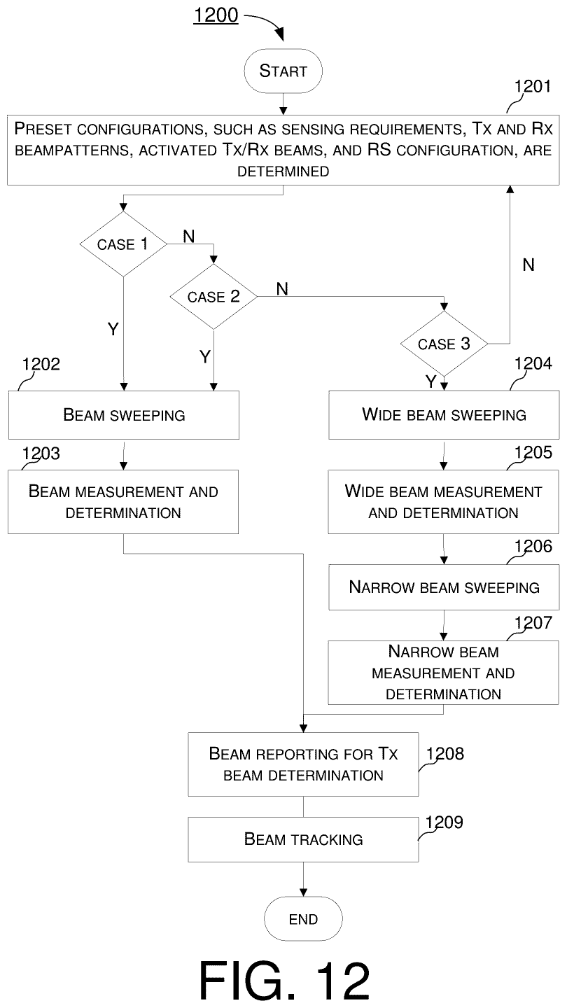

FIG. 12 illustrates an example process 1200 of beam management for bistatic sensing in accordance with an implementation of the present disclosure. Process 1200 includes multiple steps that may be executed by the collaboration between a transmitter and a receiver which are located separately from each other. To begin with, in step 1201, preset configurations, including the sensing requirements, the Tx and Rx beampatterns during beam sweeping, the activated Tx/Rx beams, and RS configuration, etc., are determined by the transmitter. The sensing requirements may be obtained by the transmitter via certain signaling interaction mechanism (as will be discussed below in FIGS. 16-17), and the sensing requirements may include the sensing scenario (i.e., monostatic sensing or bistatic sensing), the maximum detection angle, distance and velocity of interest, the RCS, and the timeliness of sensing, etc. Based on the sensing requirements, if the sensing scenario is bistatic sensing, the appropriate Tx and Rx beampatterns during beam sweeping may be selected among the three cases previously depicted in FIGS. 6-8. Given a fixed Rx beam, only partial Tx beams may be activated to illuminate the intersection area collaboratively. Given the selected Tx and Rx beampatterns during beam sweeping, the RS may be configured for the sensing requirements at the transceiver (as will be discussed below in FIG. 13). Different service requirements may correspond to different RS configurations. For example, the maximum detection velocity may be associated with the OFDM symbol spacing between two RSs, the maximum detection distance may be associated with the subcarrier spacing between two RSs, and the total number of resource elements allocated to RS may contribute to radar processing gain.

Subsequent to step 1201, if case 1 or case 2 is adopted, process 1200 may proceed to 1202. In step 1202, beam sweeping(s) is/are performed. Based on the Tx and Rx beampatterns as shown in FIG. 6 and FIG. 7, the transmitter continuously aligns with different directions, given a sweeping interval to cover the entire detection area. For each Rx direction, the Tx beams sequentially sweep towards different directions to cover more intersection area; and the Rx beams alternate sequentially until all the detection area is covered. In step 1203, beam measurement and determination are performed. For each sweeping, the radar receiver receives the reflection signal from the target object and conducts the sensing algorithm, such as periodogram-based algorithms, to estimate the target AoA, distance, and velocity.

Subsequent to step 1201, if case 3 is adopted, process 1200 may proceed to 1204. In step 1204, the wide Tx and Rx beams are generated as shown in upper part (A) of FIG. 8, and hence the corresponding wide beam sweeping is performed. For each Rx beam, given a wide sweeping interval, the transmitter sequentially aligns with different directions to cover more intersection area. The Rx beams alter the aligned directions until the entire detection area is covered. In step 1205, wide beam measurement and determination are performed. For each wide beam sweeping, the radar receiver receives the reflection signal from the target object, and conducts the sensing algorithm to obtain the RD map. The radar receiver may record the SNR of the sensing target in the RD map and select several candidate wide beams with the sensing SNR above the threshold. For example, as shown in part (A) of FIG. 8, the Tx beams 843-844, and the Rx beams 851-852 are regarded as candidate wide beams. In step 1206, the narrow Tx and Rx beams are generated during the narrow beam sweeping, as shown in the lower part (A) of FIG. 8. For each Rx beam, given a narrow sweeping interval, the transmitter scans narrow beams 861-864 within the candidate wide beams 843-844. The Rx beams alternate sequentially from narrow beam 871 to narrow beam 874 within the candidate wide beams 851-852. In step 1207, narrow beam measurement and determination are performed. For each narrow beam sweeping, the radar receiver receives the reflection signal from the target object and conducts the sensing algorithms, such as periodogram-based algorithm. The AoA may be estimated via the narrow beampattern.

Subsequent to steps 1203 and 1207, process 1200 may proceed to 1208. In step 1208, beam reporting for Tx beam determination is performed. Since the target AoA may be estimated at step 1203 or 1207, the AoD may be obtained by the transmitter via three methods of beam reporting. In the first method, given a fixed Rx beampattern, the transmitter scans the Tx beams at different instants, and the receiver reports the Tx beam identifier (ID) indicated by the RS configuration once detecting the target. However, the Tx beam cannot be uniquely determined when transmitting multiple beams in case 2 and 3, and hence the redundant beams are required additionally. In the second method, the receiver calculates the target AoD and directly reports it to the transmitter. Considering that the locations of the transmitter and the receiver are known, the target range R and AoA may be estimated at the receiver, and the AoD may be calculated based on the geographical relationship. The method of geographical localization may be used to estimate the target AoD and uniquely determine the Tx beam ID. In the third method, the receiver reports the estimated target range R and AoA to the transmitter. Assuming that the transmitter has known the location of the receiver, given the estimated target range R and AoA, the target AoD may be calculated at the transmitter. The method of geographical localization may be used to estimate the target AoD and uniquely determine the Tx beam ID.

In step 1209, beam tracking is performed (e.g., with the Tx and Rx beampatterns for beam tracking as shown in part (B) of FIG. 10). Given the estimated target AoA, the transmitter sets the AoD equal to the AoA. To generate directional Tx and Rx beams with high beam gain, all antenna subarrays point towards the estimated target AoD and AoA, respectively.

FIG. 13 illustrates an example scenario 1300 of resource allocation for RS configuration in accordance with an implementation of the present disclosure. Once a transmitter transmits a communication signal with a specific RS configuration (e.g., a sensing RS) during beam sweeping or beam tracking, the RS is reused for communication channel estimation and radar sensing. The transmitter allocates resource block 1310, 1320, or 1330, each of which includes RS and data, periodically or semi-periodically. Different service requirements correspond to different RS configurations. For example, the maximum detection velocity is associated with the OFDM symbol spacing between the RS 1311 and RS 1317, the maximum detection distance is associated with the subcarrier spacing between the RS 1311 and RS 1314, which is used to remove static clutter and estimate target velocity, and the total number of resource elements allocated to RS contributes to radar processing gain.

FIG. 14 illustrates an example scenario 1400 of a signaling interaction mechanism applied during beam management for monostatic sensing in accordance with an implementation of the present disclosure. Scenario 1400 depicts an exemplary message sequence chart of beam management involving a transmitter 1410 and a receiver 1420 collocated, e.g., in a single device such as a transceiver, where case 1 or case 2 of Tx and Rx beampatterns is adopted for beam sweeping. The Tx and Rx beampatterns of case 1 or case 2 may refer to FIG. 2 and FIG. 3, respectively. In step 1401, the case indicating the Tx and Rx beampatterns, and the beam sweeping interval are transmitted to the receiver during the preset procedure. In step 1402, the transmitter informs the receiver of the RS configuration for sensing. In step 1403, after conducting sensing algorithms to estimate the AoA, the receiver reports the estimated AoA to the transmitter. With the estimated AoA, the transmitter sets the refined angle AoD equal to the AoA and reconfigures the resources based on the sensing requirements. In step 1404, the transmitter informs the receiver of the configuration of the reconfigured RS for beam tracking.

FIG. 15 illustrates an example scenario 1500 of a signaling interaction mechanism applied during beam management for monostatic sensing in accordance with an implementation of the present disclosure. Scenario 1500 depicts an exemplary message sequence chart of beam management involving a transmitter 1510 and a receiver 1520 collocated, e.g., in a single device such as a transceiver, where case 3 of Tx and Rx beampatterns is adopted for beam sweeping. The Tx and Rx beampatterns of case 3 may refer to FIG. 4. In step 1501, the case indicating the Tx and Rx beampatterns, and the beam sweeping interval are transmitted to the receiver during the preset procedure. In step 1502, the transmitter informs the receiver of the RS configuration for sensing. In step 1503, after conducting sensing algorithms to estimate the sensing SNR in the RD map, the receiver reports the selected wide beam ID with the sensing SNR above threshold to the transmitter. In step 1504, the transmitter informs the receiver of the RS configuration for narrow beam sweeping. In step 1505, after conducting the sensing algorithms to estimate the AoA, the receiver reports the estimated AoA to the transmitter. With the estimated AoA, the transmitter sets the refined angle AoD equal to the AoA and reconfigures the resources based on the sensing requirements. In step 1506, the transmitter informs the receiver of the configuration of the reconfigured RS for beam tracking.

FIG. 16 illustrates an example scenario 1600 of a signaling interaction mechanism applied during beam management for bistatic sensing in accordance with an implementation of the present disclosure. Scenario 1600 depicts an exemplary message sequence chart of beam management involving a transmitter 1610 and a receiver 1620 located separately from each other (e.g., a UE and a BS, two UEs, or two BSs), where case 1 or case 2 of Tx and Rx beampatterns is adopted for beam sweeping. The Tx and Rx beampatterns of case 1 or case 2 may refer to FIG. 6 and FIG. 7, respectively. In step 1601, the case indicating the Tx and Rx beampatterns, and the beam sweeping interval are transmitted to the receiver during the preset procedure. In step 1602, the transmitter informs the receiver of the RS configuration for sensing. In step 1603, after conducting sensing algorithms, the receiver reports one of the following information obtained using three methods of beam reporting. In the first method, the TX beam ID with the sensing SNR above threshold is reported to the transmitter. In the second method, the target AoD is calculated by the receiver according to the geographical relationship, given the assistant information of the length of line-of-sight (LoS) path between the transmitter and the receiver. Then, the receiver directly reports the estimated AoD to the transmitter. In the third method, the receiver reports the estimated target range and AoA to the transmitter, such that the AoD may be calculated at the transmitter based on the geographical relationship. With the reported information, the transmitter reconfigures the resources based on the sensing requirements. In step 1604, the transmitter informs the receiver of the configuration of the reconfigured RS for beam tracking.

FIG. 17 illustrates an example scenario 1700 of a signaling interaction mechanism applied during beam management for bistatic sensing in accordance with an implementation of the present disclosure. Scenario 1700 depicts an exemplary message sequence chart of beam management involving a transmitter 1710 and a receiver 1720 located separately from each other (e.g., a UE and a BS, two UEs, or two BSs), where case 3 of Tx and Rx beampatterns is adopted for beam sweeping. The Tx and Rx beampatterns of case 3 may refer to FIG. 8. In step 1701, the case indicating the Tx and Rx beampatterns, and the beam sweeping interval are transmitted to the receiver during the preset procedure. In step 1702, the transmitter informs the receiver of the RS configuration for sensing. In step 1703, after conducting sensing algorithms to obtain the sensing SNR in the RD map, the receiver reports the selected wide beam ID to the transmitter with sensing SNR above threshold. In step 1704, the transmitter informs the receiver of the RS configuration for narrow beam sweeping. In step 1705, after conducting the sensing algorithms, the receiver reports one of the following information obtained using three methods of beam reporting. In the first method, the Tx beam ID with the sensing SNR above threshold is reported to the transmitter. In the second method, the target AoD is calculated by the receiver according to the geographical relationship, given the assistant information of the length of LoS path between the transmitter and the receiver. Then, the receiver directly reports the estimated AoD to the transmitter. In the third method, the receiver reports the estimated target range and AoA to the transmitter, such that the AoD may be calculated at the transmitter based on the geographical relationship. With the reported information, the transmitter reconfigures the resources based on the sensing requirements. In step 1706, the transmitter informs the receiver of the configuration of the reconfigured RS for beam tracking.

### Illustrative Implementations

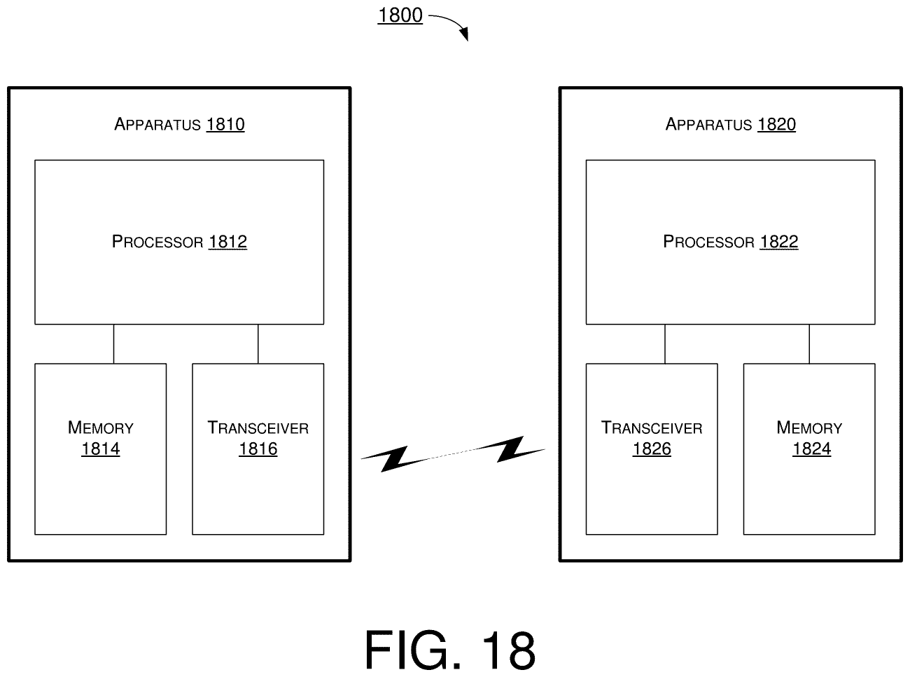

FIG. 18 illustrates an example communication system 1800 having two example apparatus 1810 and 1820 in accordance with an implementation of the present disclosure. Each of apparatus 1810 and apparatus 1820 may perform various functions to implement schemes, techniques, processes and methods described herein pertaining to sensing beam management in ISAC system, including scenarios/schemes described above as well as processes 1900 and 2000 described below.

Each of apparatus 1810 and apparatus 1820 may be a part of an electronic apparatus, which may be a UE such as a portable or mobile apparatus, a wearable apparatus, a wireless communication apparatus or a computing apparatus (e.g., mounted on vehicles). For instance, apparatus 1810/1820 may be implemented in a smartphone, a smartwatch, a personal digital assistant, a digital camera, or a computing equipment such as a tablet computer, a laptop computer or a notebook computer. Each of apparatus 1810 and apparatus 1820 may also be a part of a machine type apparatus, which may be an IoT, NB-IoT, or IIoT apparatus such as an immobile or a stationary apparatus, a home apparatus, a wire communication apparatus or a computing apparatus. For instance, apparatus 1810/1820 may be implemented in a smart thermostat, a smart fridge, a smart door lock, a wireless speaker or a home control center. Alternatively, each of apparatus 1810 and apparatus 1820 may be a part of an electronic apparatus, which may be a network node such as a BS, a small cell, a router or a gateway. For instance, apparatus 1810/1820 may be implemented in an eNB in an LTE, LTE-Advanced or LTE-Advanced Pro network or in a gNB in a 5G, NR, IoT, NB-IoT or IIoT network. Furthermore, each of apparatus 1810 and apparatus 1820 may be implemented in the form of one or more integrated-circuit (IC) chips such as, for example and without limitation, one or more single-core processors, one or more multi-core processors, one or more reduced-instruction set computing (RISC) processors, or one or more complex-instruction-set-computing (CISC) processors. Apparatus 1810/1820 may include at least some of those components shown in FIG. 18 such as a processor 1812/1822, for example. Apparatus 1810/1820 may further include one or more other components not pertinent to the proposed scheme of the present disclosure (e.g., internal power supply, display device and/or user interface device), and, thus, such component(s) of apparatus 1810/1820 are neither shown in FIG. 18 nor described below in the interest of simplicity and brevity.

In one aspect, each of processor 1812 and processor 1822 may be implemented in the form of one or more single-core processors, one or more multi-core processors, or one or more CISC processors. That is, even though a singular term “a processor” is used herein to refer to processor 1812 and processor 1822, each of processor 1812 and processor 1822 may include multiple processors in some implementations and a single processor in other implementations in accordance with the present disclosure. In another aspect, each of processor 1812 and processor 1822 may be implemented in the form of hardware (and, optionally, firmware) with electronic components including, for example and without limitation, one or more transistors, one or more diodes, one or more capacitors, one or more resistors, one or more inductors, one or more memristors and/or one or more varactors that are configured and arranged to achieve specific purposes in accordance with the present disclosure. In other words, in at least some implementations, each of processor 1812 and processor 1822 is a special-purpose machine specifically designed, arranged and configured to perform specific tasks including sensing beam management at a receiver (e.g., as represented by apparatus 1810) and a transmitter (e.g., as represented by apparatus 1810 in monostatic sensing or apparatus 1820 in bistatic sensing) in accordance with various implementations of the present disclosure.

In some implementations, apparatus 1810 may also include a transceiver 1816 coupled to processor 1812 and capable of wirelessly transmitting and receiving RSs and data signals. In some implementations, transceiver 1816 may be capable of wirelessly communicating with different types of UEs/BSs of different RATs. In some implementations, transceiver 1816 may be equipped with a plurality of antenna ports (not shown) such as, for example, four antenna ports. That is, transceiver 1816 may be equipped with multiple transmit antennas (e.g., arranged in subarrays) and multiple receive antennas (e.g., arranged in subarrays) for multiple-input multiple-output (MIMO) wireless communications. In some implementations, apparatus 1820 may also include a transceiver 1826 coupled to processor 1822 and capable of wirelessly transmitting and receiving RSs and data signals. In some implementations, transceiver 1826 may be capable of wirelessly communicating with different types of UEs/BSs of different RATs. In some implementations, transceiver 1826 may be equipped with a plurality of antenna ports (not shown) such as, for example, four antenna ports. That is, transceiver 1826 may be equipped with multiple transmit antennas (e.g., arranged in subarrays) and multiple receive antennas (e.g., arranged in subarrays) for MIMO wireless communications. Accordingly, apparatus 1810 and apparatus 1820 may wirelessly communicate with each other directly or indirectly (e.g., by reflection from any target object therebetween) via transceiver 1816 and transceiver 1826, respectively.

In some implementations, apparatus 1810 may further include a memory 1814 coupled to processor 1812 and capable of being accessed by processor 1812 and storing data therein. In some implementations, apparatus 1820 may further include a memory 1824 coupled to processor 1822 and capable of being accessed by processor 1822 and storing data therein. Each of memory 1814 and memory 1824 may include a type of random-access memory (RAM) such as dynamic RAM (DRAM), static RAM (SRAM), thyristor RAM (T-RAM) and/or zero-capacitor RAM (Z-RAM). Alternatively, or additionally, each of memory 1814 and memory 1824 may include a type of read-only memory (ROM) such as mask ROM, programmable ROM (PROM), erasable programmable ROM (EPROM) and/or electrically erasable programmable ROM (EEPROM). Alternatively, or additionally, each of memory 1814 and memory 1824 may include a type of non-volatile random-access memory (NVRAM) such as flash memory, solid-state memory, ferroelectric RAM (FeRAM), magnetoresistive RAM (MRAM) and/or phase-change memory.

Each of apparatus 1810 and apparatus 1820 may be a communication entity capable of communicating with each other using various proposed schemes in accordance with the present disclosure. For illustrative purposes and without limitation, a description of operations, functionalities, and capabilities of apparatus 1810, implemented in or as a sensing receiver (e.g., a UE or a BS), and apparatus 1820, implemented in or as a sensing transmitter (e.g., a UE or a BS), is provided below with processes 1900 and 2000.

### Illustrative Processes

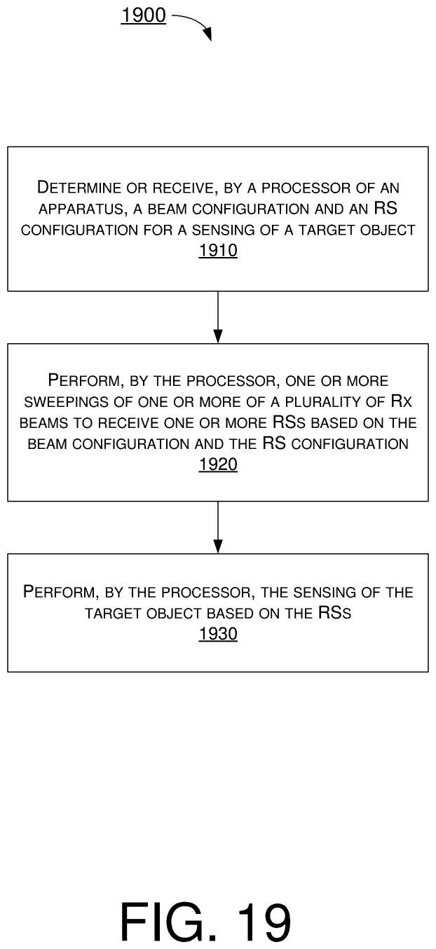

FIG. 19 illustrates an example process 1900 in accordance with an implementation of the present disclosure. Process 1900 may be an example implementation of above scenarios/schemes, whether partially or completely, with respect to sensing beam management in ISAC system. Process 1900 may represent an aspect of implementation of features of apparatus 1810. Process 1900 may include one or more operations, actions, or functions as illustrated by one or more of blocks 1910 to 1930. Although illustrated as discrete blocks, various blocks of process 1900 may be divided into additional blocks, combined into fewer blocks, or eliminated, depending on the desired implementation. Moreover, the blocks of process 1900 may be executed in the order shown in FIG. 19 or, alternatively, in a different order. Process 1900 may be implemented by apparatus 1810 or any suitable UE or BS. Solely for illustrative purposes and without limitation, process 1900 is described below in the context of apparatus 1810 as a sensing receiver and apparatus 1820 as a sensing transmitter. Process 1900 may begin at block 1910.

At 1910, process 1900 may involve processor 1812 of apparatus 1810 determining or receiving, via transceiver 1816, a beam configuration and an RS configuration for a sensing of a target object. Process 1900 may proceed from 1910 to 1920.

At 1920, process 1900 may involve processor 1812 performing, via transceiver 1816, one or more sweepings of one or more of a plurality of Rx beams to receive one or more RSs based on the beam configuration and the RS configuration. Process 1900 may proceed from 1920 to 1930.

At 1930, process 1900 may involve processor 1812 performing, via transceiver 1816, the sensing of the target object based on the RSs.

In some implementations, the beam configuration may indicate at least one of Tx and Rx beampatterns and activated Tx and Rx beams for the sweepings, and the RS configuration may indicate one or more time and frequency resources of the RSs.

In some implementations, the beam configuration and the RS configuration may be based on sensing requirements comprising at least one of the following: (i) a sensing scenario indicating monostatic sensing or bistatic sensing; (ii) a maximum detection angle; (iii) a distance and a velocity of interest; (iv) an RCS; and (v) a timeliness of sensing.

In some implementations, the one or more Rx beams activated for the sweepings may include only partial of the plurality of Rx beams based on a detection area of the sensing.

In some implementations, during each of the sweepings, all of a plurality of antenna subarrays of the apparatus may be configured to point towards a specific direction to form a narrow beam at a time.

In some implementations, during each of the sweepings, each of a plurality of antenna subarrays of the apparatus may be configured to point towards a respective direction to form a plurality of wide beams at a time.

In some implementations, during one of the sweepings, each of a plurality of antenna subarrays of the apparatus may be configured to point towards a respective direction to form a plurality of wide beams at a time, and during another one of the sweepings, all of the antenna subarrays of the apparatus are configured to point towards a specific direction to form a narrow beam at a time.

In some implementations, process 1900 may further involve processor 1812 reporting, via transceiver 1816, a beam ID of a Tx beam with a sensing SNR above a threshold, an AoD of the RSs, or an AoA of the RSs and a range between apparatus 1810 and the target object, to apparatus 1820 transmitting the RSs.

In some implementations, during the sensing of the target object, a spacing along an OFDM symbol axis within a CPI may be used to remove a static clutter.

In some implementations, process 1900 may further involve processor 1812 determining one of the one or more Rx beams for tracking the target object based on a result of the sensing.

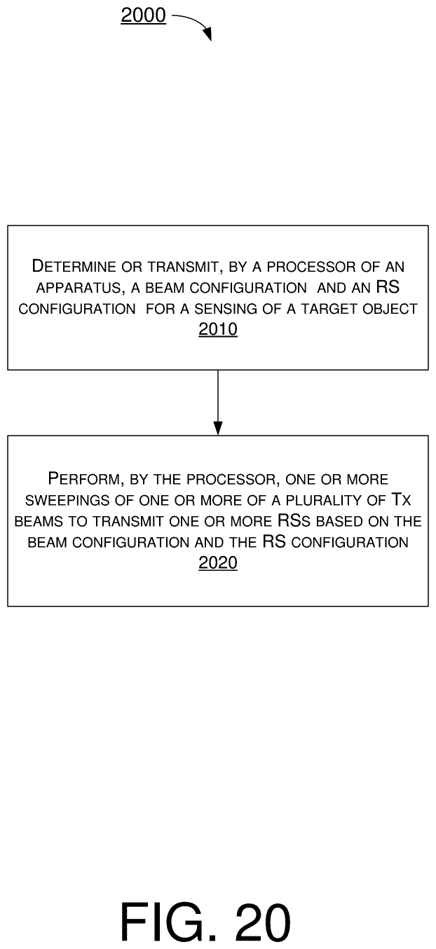

FIG. 20 illustrates an example process 2000 in accordance with an implementation of the present disclosure. Process 2000 may be an example implementation of above scenarios/schemes, whether partially or completely, with respect to sensing beam management in ISAC system. Process 2000 may represent an aspect of implementation of features of apparatus 1820. Process 2000 may include one or more operations, actions, or functions as illustrated by one or more of blocks 2010 and 2020. Although illustrated as discrete blocks, various blocks of process 2000 may be divided into additional blocks, combined into fewer blocks, or eliminated, depending on the desired implementation. Moreover, the blocks of process 2000 may be executed in the order shown in FIG. 20 or, alternatively, in a different order. Process 2000 may be implemented by apparatus 1820 or any suitable UE or BS. Solely for illustrative purposes and without limitation, process 2000 is described below in the context of apparatus 1820 as a sensing transmitter and apparatus 1810 as a sensing receiver. Process 2000 may begin at block 2010.

At 2010, process 2000 may involve processor 1822 of apparatus 1820 determining or transmitting, via transceiver 1826, a beam configuration and an RS configuration for a sensing of a target object. Process 2000 may proceed from 2010 to 2020.

At 2020, process 2000 may involve processor 1822 performing, via transceiver 1826, one or more sweepings of one or more of a plurality of Tx beams to transmit one or more RSs based on the beam configuration and the RS configuration.

In some implementations, the beam configuration may indicate at least one of Tx and Rx beampatterns and activated Tx and Rx beams for the sweepings, and the RS configuration may indicate one or more time and frequency resources of the RSs.

In some implementations, the beam configuration and the RS configuration may be based on sensing requirements comprising at least one of the following: (i) a sensing scenario indicating monostatic sensing or bistatic sensing; (ii) a maximum detection angle; (iii) a distance and a velocity of interest; (iv) an RCS; and (v) a timeliness of sensing.

In some implementations, the one or more Tx beams activated for the sweepings may include only partial of the plurality of Tx beams based on a detection area of the sensing.

In some implementations, during each of the sweepings, all of a plurality of antenna subarrays of the apparatus may be configured to point towards a specific direction to form a narrow beam at a time.

In some implementations, during each of the sweepings, each of a plurality of antenna subarrays of the apparatus may be configured to point towards a respective direction to form a plurality of wide beams at a time.

In some implementations, during one of the sweepings, each of a plurality of antenna subarrays of the apparatus may be configured to point towards a respective direction to form a plurality of wide beams at a time, and during another one of the sweepings, all of the antenna subarrays of the apparatus are configured to point towards a specific direction to form a narrow beam at a time.

In some implementations, process 2000 may further involve processor 1822 receiving, via transceiver 1826, a beam ID of one of the one or more Tx beams with a sensing SNR above a threshold, an AoD of the RSs, or an AoA of the RSs and a range between apparatus 1810 receiving the RSs and the target object, from apparatus 1810.

In some implementations, during the sensing of the target object, a spacing along an OFDM symbol axis within a CPI may be used to remove a static clutter.

In some implementations, process 2000 may further involve processor 1822 determining one of the one or more Tx beams for tracking the target object based on a result of the sensing.

### Additional Notes

The herein-described subject matter sometimes illustrates different components contained within, or connected with, different other components. It is to be understood that such depicted architectures are merely examples, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected”, or “operably coupled”, to each other to achieve the desired functionality, and any two components capable of being so associated can also be viewed as being “operably couplable”, to each other to achieve the desired functionality. Specific examples of operably couplable include but are not limited to physically mateable and/or physically interacting components and/or wirelessly interactable and/or wirelessly interacting components and/or logically interacting and/or logically interactable components.

Further, with respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

Moreover, it will be understood by those skilled in the art that, in general, terms used herein, and especially in the appended claims, e.g., bodies of the appended claims, are generally intended as “open” terms, e.g., the term “including” should be interpreted as “including but not limited to,” the term “having” should be interpreted as “having at least,” the term “includes” should be interpreted as “includes but is not limited to,” etc. It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to implementations containing only one such recitation, even when the same claim includes the introductory phrases “one or more” or “at least one” and indefinite articles such as “a” or “an,” e.g., “a” and/or “an” should be interpreted to mean “at least one” or “one or more;” the same holds true for the use of definite articles used to introduce claim recitations. In addition, even if a specific number of an introduced claim recitation is explicitly recited, those skilled in the art will recognize that such recitation should be interpreted to mean at least the recited number, e.g., the bare recitation of “two recitations,” without other modifiers, means at least two recitations, or two or more recitations. Furthermore, in those instances where a convention analogous to “at least one of A, B, and C, etc.” is used, in general such a construction is intended in the sense one having skill in the art would understand the convention, e.g., “a system having at least one of A, B, and C” would include but not be limited to systems that have A alone, B alone, C alone, A and B together, A and C together, B and C together, and/or A, B, and C together, etc. In those instances where a convention analogous to “at least one of A, B, or C, etc.” is used, in general such a construction is intended in the sense one having skill in the art would understand the convention, e.g., “a system having at least one of A, B, or C” would include but not be limited to systems that have A alone, B alone, C alone, A and B together, A and C together, B and C together, and/or A, B, and C together, etc. It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

From the foregoing, it will be appreciated that various implementations of the present disclosure have been described herein for purposes of illustration, and that various modifications may be made without departing from the scope and spirit of the present disclosure. Accordingly, the various implementations disclosed herein are not intended to be limiting, with the true scope and spirit being indicated by the following claims.

What is claimed is:

1. A method, comprising:
determining or receiving, by a processor of an apparatus, a beam configuration and a reference signal (RS) configuration for a sensing of a target object;
performing, by the processor, one or more sweepings of one or more of a plurality of receiving (Rx) beams to receive one or more RSs based on the beam configuration and the RS configuration; and
performing, by the processor, the sensing of the target object based on the RSs.

2. The method of claim 1, wherein the beam configuration indicates at least one of transmitting (Tx) and Rx beampatterns and activated Tx and Rx beams for the sweepings, and the RS configuration indicates one or more time and frequency resources of the RSs.

3. The method of claim 1, wherein the beam configuration and the RS configuration are based on sensing requirements comprising at least one of the following:
a sensing scenario indicating monostatic sensing or bistatic sensing;
a maximum detection angle;
a distance and a velocity of interest;
a radar cross section (RCS); and
a timeliness of sensing.

4. The method of claim 1, wherein the one or more Rx beams activated for the sweepings comprise only partial of the plurality of Rx beams based on a detection area of the sensing.

5. The method of claim 1, wherein, during each of the sweepings, all of a plurality of antenna subarrays of the apparatus are configured to point towards a specific direction to form a narrow beam at a time.

6. The method of claim 1, wherein, during each of the sweepings, each of a plurality of antenna subarrays of the apparatus is configured to point towards a respective direction to form a plurality of wide beams at a time.

7. The method of claim 1, wherein, during one of the sweepings, each of a plurality of antenna subarrays of the apparatus is configured to point towards a respective direction to form a plurality of wide beams at a time, and during another one of the sweepings, all of the antenna subarrays of the apparatus are configured to point towards a specific direction to form a narrow beam at a time.

8. The method of claim 1, further comprising:
reporting, by the processor, a beam identifier (ID) of a transmitting (Tx) beam with a sensing signal-to-noise ratio (SNR) above a threshold, an angle of departure (AoD) of the RSs, or an angle of arrival (AoA) of the RSs and a range between the apparatus and the target object, to another apparatus transmitting the RSs.

9. The method of claim 1, wherein, during the sensing of the target object, a spacing along an orthogonal frequency division multiplexing (OFDM) symbol axis within a coherent processing interval (CPI) is used to remove a static clutter.

10. The method of claim 1, further comprising:
determining, by the processor, one of the one or more Rx beams for tracking the target object based on a result of the sensing.

11. A method, comprising:
determining or transmitting, by a processor of an apparatus, a beam configuration and a reference signal (RS) configuration for a sensing of a target object; and
performing, by the processor, one or more sweepings of one or more of a plurality of transmitting (Tx) beams to transmit one or more RSs based on the beam configuration and the RS configuration.

12. The method of claim 11, wherein the beam configuration indicates at least one of Tx and receiving (Rx) beampatterns and activated Tx and Rx beams for the sweepings, and the RS configuration indicates one or more time and frequency resources of the RSs.

13. The method of claim 11, wherein the beam configuration and the RS configuration are based on sensing requirements comprising at least one of the following:
a sensing scenario indicating monostatic sensing or bistatic sensing;
a maximum detection angle;
a distance and a velocity of interest;
a radar cross section (RCS); and
a timeliness of sensing.

14. The method of claim 11, wherein the one or more Tx beams activated for the sweepings comprise only partial of the plurality of Tx beams based on a detection area of the sensing.

15. The method of claim 11, wherein, during each of the sweepings, all of a plurality of antenna subarrays of the apparatus are configured to point towards a specific direction to form a narrow beam at a time.

16. The method of claim 11, wherein, during each of the sweepings, each of a plurality of antenna subarrays of the apparatus is configured to point towards a respective direction to form a plurality of wide beams at a time.

17. The method of claim 11, wherein, during one of the sweepings, each of a plurality of antenna subarrays of the apparatus is configured to point towards a respective direction to form a plurality of wide beams at a time, and during another one of the sweepings, all of the antenna subarrays of the apparatus are configured to point towards a specific direction to form a narrow beam at a time.

18. The method of claim 11, further comprising:
receiving, by the processor, a beam identifier (ID) of one of the one or more Tx beams with a sensing signal-to-noise ratio (SNR) above a threshold, an angle of departure (AoD) of the RSs, or an angle of arrival (AoA) of the RSs and a range between another apparatus receiving the RSs and the target object, from the other apparatus.

19. The method of claim 11, wherein, during the sensing of the target object, a spacing along an orthogonal frequency division multiplexing (OFDM) symbol axis within a coherent processing interval (CPI) is used to remove a static clutter.

20. An apparatus, comprising:
a transceiver which, during operation, wirelessly transmits and receives signals; and
a processor communicatively coupled to the transceiver such that, during operation, the processor performs operations comprising:
determining or receiving, via the transceiver, a beam configuration and a reference signal (RS) configuration for a sensing of a target object;
performing, via the transceiver, one or more sweepings of one or more of a plurality of receiving (Rx) beams to receive one or more RSs based on the beam configuration and the RS configuration; and
performing, via the transceiver, the sensing of the target object based on the RSs.
